(19) United States
(12) Patent Application Publication
(10) Pub. No.: US 2022/0282181 A1
(43) Pub. Date: Sep. 8, 2022

(54) HARD SURFACE CLEANING COMPOSITION COMPRISING POLYALKYLENE GLYCOL

(71) Applicant: The Procter & Gamble Company, Cincinnati, OH (US)

(72) Inventors: Cindy JEAN, HOUDENG-AIMERIES (LA LOUVIERE) (BE); Jean-Francois BODET, Waterloo (BE)

(21) Appl. No.: 17/685,420

(22) Filed: Mar. 3, 2022

(30) Foreign Application Priority Data
Mar. 4, 2021 (EP) 21160782.5

(51) Int. Cl. C11D 1/86; C11D 1/14; C11D 1/75; C11D 1/72; C11D 3/50; C11D 3/37; C11D 11/00; C11D 17/00

(52) U.S. Cl. CPC C11D 1/86; C11D 1/146; C11D 1/75; C11D 1/72; C11D 3/50; C11D 3/3707; C11D 11/0023; C11D 17/0008

(57) ABSTRACT

An aqueous hard surface cleaning composition having from about 0.1% to about 5% by weight of the composition of a surfactant system, from about 0.1% to about 5% by weight of the composition of polyalkylene glycol having a weight average molecular weight from 2,000 to 12,000 and from about 0.1% to about 5% by weight of the composition of perfume.

### FIELD OF THE INVENTION

The present invention is in the field of cleaning compositions, in particular, it relates to a hard surface cleaning composition comprising surfactant, perfume and polyalkylene glycol. It also relates to a method of cleaning a hard surface using the composition of the invention and the use of a polyalkylene glycol in a hard surface cleaning composition to provide perfume emulsification and improved shine.

### BACKGROUND OF THE INVENTION

Hard surface cleaning compositions are used for cleaning and treating hard surfaces. Preferably, the hard surface cleaning composition is formulated to be an “all purpose” hard surface cleaning composition. That is, the hard surface cleaning composition is formulated to be suitable for cleaning as many different kinds of surfaces as possible.

Users not only seek cleaning but also pleasant smell and shine on the surface cleaned. A dichotomy does exist in traditional compositions, the more perfume in the composition, the more surfactant is required to emulsify the perfume and keep the composition clear. The increase of surfactant can impact on shine. It is also difficult to stabilize a relatively high level of perfume in aqueous compositions.

A need remains for a hard surface cleaning composition which provides improved scent during use and improved shine.

### SUMMARY OF THE INVENTION

According to the first aspect of the invention, there is provided a hard surface cleaning composition. The composition is aqueous and comprises:

(a) from about 0.1% to about 5% by weight of the composition of a surfactant system;
(b) from about 0.1% to about 5% by weight of the composition of polyalkylene glycol having a weight average molecular weight from 2,000 to 12,000; and
(c) from about 0.1% to about 5% by weight of the composition of perfume.

The composition is stable, even with high level of perfume and it provides improved shine to the hard surface. Without being bound by theory, it is believed that the polyalkylene glycol helps with perfume emulsification, stability and at the same time contributes to improve the shine provided by the composition. The presence of polyalkylene glycol in the composition allows the emulsification of higher level of perfume, without compromising stability and increasing the shine provided by the composition. The presence of polyalkylene glycol in the composition also contributes to the chemical stability of the perfume raw materials.

According to the second aspect of the invention, there is provided a method of cleaning a hard surface, e.g. a floor. The method comprises the steps of: optionally diluting the hard surface cleaning composition of the invention; applying the hard surface cleaning composition to the hard surface; and optionally rinsing and/or wiping the surface. The method provides good cleaning and improved shine and more intensive perfume than methods using traditional hard surface compositions.

According to the third aspect of the invention, there is provided the use of polyalkylene glycol having a weight average molecular weight from 2,000 to 12,000 in a composition comprising surfactant and perfume to increase perfume emulsification and to improve shine. The elements of the composition of the invention described in relation to the first aspect of the invention apply mutatis mutandis to the other aspects of the invention.

### DETAILED DESCRIPTION OF THE INVENTION

The aqueous hard surface cleaning composition of the present invention provides good cleaning, improved shine and very pleasant olfactory experience. The composition of the invention is clear and the perfume raw materials present improved chemical stability. The composition of the invention is isotropic and stable.

As defined herein, “essentially free of” a component means that no amount of that component is deliberately incorporated into the respective premix, or composition. “Essentially free of” a component means that no amount of that component is present in the respective premix, or composition.

As used herein, “isotropic” means a clear mixture, having little or no visible haziness, phase separation and/or dispersed particles, and having a uniform transparent appearance.

As defined herein, “stable” means that no visible phase separation is observed for a composition kept at 25° C. for a period of at least two weeks, or at least four weeks, or greater than a month or greater than four months, as measured using the Floc Formation Test, described in USPA 2008/0263780 A1.

All percentages, ratios and proportions used herein are by weight percent of the composition, unless otherwise specified. All average values are calculated “by weight” of the composition, unless otherwise expressly indicated.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

### Aqueous Hard Surface Cleaning Compositions

By “aqueous hard surface cleaning composition”, it is meant herein a water based liquid composition for cleaning hard surfaces found in households, especially domestic households. Surfaces to be cleaned include kitchens and bathrooms, e.g., floors, walls, tiles, windows, cupboards, sinks, showers, shower plastified curtains, wash basins, WCs, fixtures and fittings and the like made of different materials like ceramic, vinyl, no-wax vinyl, linoleum, melamine, glass, steel, kitchen work surfaces, any plastics, plastified wood, metal or any painted or varnished or sealed surface and the like. Household hard surfaces also include household appliances including, but not limited to refrigerators, freezers, washing machines, automatic dryers, ovens, microwave ovens, dishwashers and so on. Such hard surfaces may be found both in private households as well as in commercial, institutional and industrial environments. The composition of the invention is especially suitable for the cleaning and treatment of floors.

The composition herein is an aqueous composition. Therefore, they may comprise from 80% to 99.5% by weight of the total composition of water, from 90% to 98% and from 92% to 96%.

The composition of the present invention has a pH which is greater than 5.0, measured on the neat composition, at 25° C., from 6.0 to 12, or from 7.0 to 11.5. It is believed that the greasy soil and particulate greasy soil cleaning performance is further improved at these alkaline pH ranges, while surface safety is maintained. Accordingly, the compositions herein may further comprise an acid or base to adjust pH as appropriate.

A suitable acid of use herein is an organic and/or an inorganic acid. An organic acid of use herein has a pKa of less than 6. A suitable organic acid is selected from the group consisting of: citric acid, lactic acid, glycolic acid, succinic acid, glutaric acid and adipic acid and mixtures thereof. A suitable inorganic acid can be selected from the group consisting of: hydrochloric acid, sulphuric acid, phosphoric acid and mixtures thereof. Citric acid can be the preferred acid for use herein.

A typical level of such acids, when present, is from 0.001% to 5.0% by weight of the total composition, from 0.002% to 3.0% and from 0.005% to 1.5%.

A suitable base to be used herein is an organic and/or inorganic base. Suitable bases of use herein are the caustic alkalis, such as sodium hydroxide, potassium hydroxide and/or lithium hydroxide, and/or the alkali metal oxides such, as sodium and/or potassium oxide or mixtures thereof. A base can be a caustic alkali, sodium hydroxide and/or potassium hydroxide.

Other suitable bases include ammonia, ammonium carbonate, potassium carbonate, sodium carbonate, sodium bicarbonate, and alkanolamines (such as monoethanolamine, triethanolamine, aminomethylpropanol, and mixtures thereof), nitrogenous buffers, and mixtures thereof. Suitable nitrogenous buffers include: ammonium or alkaline earth carbamates, guanidine derivatives, ammonium carbonate, ammonium bicarbonate, diammonium carbonate, ammonium hydroxide, ammonia (which forms ammonium hydroxide in situ when added to water) and mixtures thereof. Typical levels of such bases, when present, are from 0.01% to 5.0% by weight of the total composition, from 0.05% to 3.0% and from 0.1% to 2.0%.

All ratios are calculated as a weight/weight level, unless otherwise specified.

### Polyethylene Glycol (PEG)

Polyethylene glycol (PEG) comes in various weight average molecular weights. A suitable weight average molecular weight range of PEG for the purposes of the present invention includes from 2,000 to about 12,000, from 3,000 to 10,000 3,500 to 10,000, 6,000 to 10,000, for example from about 7,000 to about 9,000, or any combinations thereof. PEG is available from BASF, for example PLURIOL® E 8000 or PolyOxυ, supplied by DOW.

The composition of the invention comprises from about 0.1% to about 5%, from about 0.2% to 3%, from 0.5% to 2% by weight of the composition of polyethylene glycol.

### Surfactant System

The cleaning composition comprises from 0.1% to 5%, from 1 to 4% by weight of a surfactant system. The surfactant system comprises more than one surfactant selected from the group consisting of anionic surfactant, non-ionic surfactant, amine oxide surfactant, betaine surfactant and mixtures thereof. The surfactant system comprises and anionic surfactant, a non-ionic surfactant and optionally an amine oxide surfactant.

### Amine Oxide Surfactant

The hard surface cleaning composition comprises 0.1% to 2%, from 0.2% to 1% by weight of the composition.

Suitable amine oxide surfactants include: R₁R₂R₃NO wherein each of R₁, R₂ and R₃ is independently a saturated or unsaturated, substituted or unsubstituted, linear or branched hydrocarbon chain having from 10 to 30 carbon atoms. Amine oxide surfactants are amine oxides having the following formula: R₁R₂R₃NO wherein R₁ is an hydrocarbon chain comprising from 1 to 30 carbon atoms, from 6 to 20, from 8 to 16 and wherein R₂ and R₃ are independently saturated or unsaturated, substituted or unsubstituted, linear or branched hydrocarbon chains comprising from 1 to 4 carbon atoms, from 1 to 3 carbon atoms, and are methyl groups. R₁ may be a saturated or unsaturated, substituted or unsubstituted linear or branched hydrocarbon chain.

A highly preferred amine oxide is C₁₂-C₁₄ dimethyl amine oxide, commercially available from Albright & Wilson, C₁₂-C₁₄ amine oxides commercially available under the trade name Genaminox® LA from Clariant or AROMOX® DMC from AKZO Nobel.

### Betaine and Sulfobetaine Surfactant

The composition of the invention can comprise betaine and/or sulfobetaine surfactants according to the formulae:

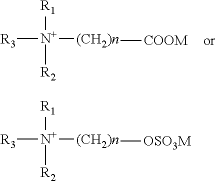

wherein: R₁ and R₂ are each independently linear or branched, saturated or unsaturated hydrocarbon chains of from 1 to 30 carbon atoms, 1 to 20, 1 to 7 carbon atoms; R₃ is a linear or branched hydrocarbon chain of from 10 to 20 carbon atoms, preferably of from 10 to 18, 12 to 16 carbon atoms; n is an integer of from 1 to 20, 1 to 10, 1 to 5; and M is H or an alkali metal, or mixtures thereof.

Suitable betaine surfactant includes coconut-dimethyl betaine commercially available under tradename Mackam35® from McIntyre.

### Nonionic Surfactant

The surfactant system can also include a nonionic surfactant selected from the group consisting of: alkoxylated nonionic surfactants, alkyl polyglycosides, and mixture thereof. Suitable alkoxylated nonionic surfactants include primary C₆-C₁₆ alcohol polyglycol ether i.e. ethoxylated alcohols having 6 to 16 carbon atoms in the alkyl moiety and 4 to 30 ethylene oxide (EO) units. When referred to for example C₉₋₁₄ it is meant average carbons and alternative reference to for example EO8 is meant average ethylene oxide units.

Suitable alkoxylated nonionic surfactants are according to the formula RO-(A)ₙH, wherein: R is a C₆ to C₁₈, a C₈ to C₁₆, a C₈ to C₁₂ alkyl chain, or a C₆ to C₂₈ alkyl benzene chain; A is an ethoxy or propoxy or butoxy unit, and wherein n is from 1 to 30, from 1 to 15, from 4 to 12 even from 5 to 10. Preferred R chains of use herein can be the C₈ to C₂₂ alkyl chains. Even more preferred R chains of use herein can be the C₉ to C₁₂ alkyl chains. R can be linear or branched alkyl chain.

Suitable ethoxylated nonionic surfactants of use herein are Dobanol® 91-2.5 (HLB=8.1; R is a mixture of C₉ and C₁₁ alkyl chains, n is 2.5), Dobanol® 91-10 (HLB=14.2 ; R is a mixture of C₉ to C₁₁ alkyl chains, n is 10), Dobanol® 91-12 (HLB=14.5 ; R is a mixture of C₉ to C₁₁ alkyl chains, n is 12), Greenbentine DE80 (HLB=13.8, 98 wt % C10 linear alkyl chain, n is 8), Marlipal 10-8 (HLB=13.8, R is a C10 linear alkyl chain, n is 8), Lialethl® 11-5 (R is a C₁₁ alkyl chain, n is 5), Isalchem® 11-5 (R is a mixture of linear and branched C11 alkyl chain, n is 5), Lialethl® 11-21 (R is a mixture of linear and branched C₁₁ alkyl chain, n is 21), Isalchem® 11-21 (R is a C₁₁ branched alkyl chain, n is 21), Empilan® KBE21 (R is a mixture of C₁₂ and C₁₄ alkyl chains, n is 21) or mixtures thereof. Preferred herein are Dobanol® 91-5, Neodol® 11-5, Lialethl® 11-21 Lialethl® 11-5 Isalchem® 11-5 Isalchem® 11-21 Dobanol® 91-8, or Dobanol® 91-10, or Dobanol® 91-12, or mixtures thereof. These Dobanol®/Neodol® surfactants are commercially available from SHELL. These Lutensol® surfactants are commercially available from BASF and these Tergitol® surfactants are commercially available from Dow Chemicals.

Suitable chemical processes for preparing the alkoxylated nonionic surfactants of use herein include condensation of corresponding alcohols with alkylene oxide, in the desired proportions. Such processes are well known to the person skilled in the art and have been extensively described in the art, including the OXO process and various derivatives thereof. Suitable alkoxylated fatty alcohol nonionic surfactants, produced using the OXO process, have been marketed under the tradename NEODOL® by the Shell Chemical Company. Alternatively, suitable alkoxylated nonionic surfactants can be prepared by other processes such as the Ziegler process, in addition to derivatives of the OXO or Ziegler processes.

Said alkoxylated nonionic surfactant is a C₉₋₁₁ EO5 alkylethoxylate, C₁₂₋₁₄ EO5 alkylethoxylate, a C₁₁EO5 alkylethoxylate, C₁₂₋₁₄ EO21 alkylethoxylate, or a C₉₋₁₁ EO8 alkylethoxylate or a mixture thereof. Said alkoxylated nonionic surfactant can be a C₁₁ EO5 alkylethoxylate or a C₉₋₁₁ EO8 alkylethoxylate or a mixture thereof.

Alkyl polyglycosides are biodegradable nonionic surfactants which are well known in the art. Suitable alkyl polyglycosides can have the general formula CₙH₂ₙ₊₁O(C₆H₁₀O₅)ₓH wherein n is from 9 to 16, from 11 to 14, and x is from 1 to 2, from 1.3 to 1.6. Such alkyl polyglycosides provide a good balance between anti-foam activity and detergency. Alkyl polyglycoside surfactants are commercially available in a large variety. An example of a very suitable alkyl poly glycoside product is Planteren APG 600, which is essentially an aqueous dispersion of alkyl polyglycosides wherein n is about 13 and x is about 1.4.

The composition can comprise from 0.5% to 5%, from 1% to 3% by weight of the composition of alkoxylated nonionic surfactant, e.g. ethoxylated alcohol.

The composition can comprise: from 0.1% to 1%, from 0.2% to 0.8% by weight of the composition of amine oxide surfactant, C12/C14 amine oxide; and from 0.5% to 3%, from 1% to 2% by weight of the composition of alkoxylated nonionic surfactant, e.g. ethoxylated alcohol.

The nonionic surfactant can preferably be a low molecular weight nonionic surfactant, having a molecular weight of less than 950 g/mol or less than 500 g/mol.

### Anionic Surfactant

The hard surface cleaning composition may comprise an anionic surfactant. The anionic surfactant can be selected from the group consisting of: alkyl sulphate, alkyl alkoxylated sulphate, sulphonic acid or sulphonate surfactant, carboxylated anionic surfactant, and mixtures thereof, carboxylated anionic surfactant such as those selected from the group consisting of: polycarboxylated anionic surfactants, alkyl ether carboxylates, alkyl polyglycosides ether carboxylates, and mixtures thereof, or polycarboxylated anionic surfactants. The anionic surfactant can be present at a level of from 0.05% to 2%, from 0.1% to 1% by weight of the composition. The anionic surfactant can be an alkyl sulfate surfactant.

Suitable alkyl sulphates of use herein include water-soluble salts or acids of the formula ROSO₃M wherein R is a C₆-C₁₈ linear or branched, saturated or unsaturated alkyl group, a C₈-C₁₆ alkyl group and a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperidinium cations and quaternary ammonium cations derived from alkylamines such as ethylamine, diethylamine, triethylamine, and mixtures thereof, and the like).

Particularly suitable linear alkyl sulphates include C₁₂₋₁₄ alkyl sulphate like EMPICOL® 0298/, EMPICOL® 0298/F or EMPICOL® XLB commercially available from Huntsman. By “linear alkyl sulphate” it is meant herein a non-substituted alkyl sulphate wherein the linear alkyl chain comprises from 6 to 16 carbon atoms, from 8 to 14 carbon atoms, and from 10 to 14 carbon atoms, and wherein this alkyl chain is sulphated at one terminus.

Suitable sulphonated anionic surfactants of use herein are all those commonly known by those skilled in the art. The sulphonated anionic surfactants of use herein can be selected from the group consisting of: alkyl sulphonates; alkyl aryl sulphonates; naphthalene sulphonates; alkyl alkoxylated sulphonates; and C₆-C₁₆ alkyl alkoxylated linear or branched diphenyl oxide disulphonates; and mixtures thereof.

Suitable alkyl sulphonates of use herein include water-soluble salts or acids of the formula RSO₃M wherein R is a C₆-C₁₈ linear or branched, saturated or unsaturated alkyl group, e.g. a C₈-C₁₆ alkyl group, a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperidinium cations and quaternary ammonium cations derived from alkylamines such as ethylamine, diethylamine, triethylamine, and mixtures thereof, and the like).

Suitable alkyl aryl sulphonates of use herein include water-soluble salts or acids of the formula RSO₃M wherein R is an aryl, a benzyl, substituted by a C₆-C₁₈ linear or branched saturated or unsaturated alkyl group, a C₈-C₁₆ alkyl group or a C₁₀-C₁₆ alkyl group, and M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphonates include C₁₂-C₁₆ paraffin sulphonate like Hostapur® SAS commercially available from Clariant. Particularly preferred alkyl aryl sulphonates are alkyl benzene sulphonates commercially available under trade name Nansa® available from Huntsman.

By “linear alkyl sulphonate” it is meant herein a non-substituted alkyl sulphonate wherein the alkyl chain comprises from 6 to 18 carbon atoms, from 8 to 16 carbon atoms, and from 10 to 16 carbon atoms, and wherein this alkyl chain is sulphonated at one terminus.

Suitable alkoxylated sulphonate surfactants of use herein are according to the formula R(A)ₘSO₃M, wherein R is an unsubstituted C₆-C₁₈ alkyl, hydroxyalkyl or alkyl aryl group, having a linear or branched C₆-C₁₈ alkyl component, a C₈-C₁₆ alkyl or hydroxyalkyl, a C₁₂-C₁₆ alkyl or hydroxyalkyl, and A is an ethoxy or propoxy or butoxy unit, and m is greater than zero, typically between 0.5 and 6, between 0.5 and 3, and M is H or a cation which can be, for example, a metal cation (e.g., sodium, potassium, lithium, calcium, magnesium, etc.), ammonium or substituted-ammonium cation. Alkyl ethoxylated sulphonates, alkyl butoxylated sulphonates as well as alkyl propoxylated sulphonates are contemplated herein. Specific examples of substituted ammonium cations include methyl-, dimethyl-, trimethyl-ammonium and quaternary ammonium cations, such as tetramethyl-ammonium, dimethyl piperidinium and cations derived from alkanolamines such as ethylamine, diethylamine, triethylamine, mixtures thereof, and the like.

Exemplary surfactants are C₁₂-C₁₈ alkyl polyethoxylate (1.0) sulphonate (C₁₂-C₁₈E(1.0)SM), C₁₂-C₁₈ alkyl polyethoxylate (2.25) sulphonate (C₁₂-C₁₈E(2.25)SM), C₁₂-C₁₈ alkyl polyethoxylate (3.0) sulphonate (C₁₂-C₁₈E(3.0)SM), and C₁₂-C₁₈ alkyl polyethoxylate (4.0) sulphonate (C₁₂-C₁₈E(4.0)SM), wherein M is conveniently selected from sodium and potassium. Particularly suitable alkoxylated sulphonates include alkyl aryl polyether sulphonates like Triton X-200® commercially available from Dow Chemical.

Said sulphated or sulphonated anionic surfactant of use herein is selected from the group consisting of alkyl sulphates (AS), e.g. C₁₂, C₁₃, C₁₄ and C₁₅ AS, sodium linear alkyl sulphonate (NaLAS), sodium paraffin sulphonate NaPC₁₂₋₁₆S, and mixtures thereof. Sulphated or sulphonated anionic surfactant of use herein can be selected from the group consisting of alkyl sulphates (AS), C₁₂, C₁₃, C₁₄ and C₁₅ AS, sodium linear alkyl sulphonate (NaLAS), sodium paraffin sulphonate NaPC₁₂₋₁₆S and mixtures thereof.

Typically, the liquid composition herein may comprise from 0.1% to 1% by weight of the total composition of said sulphated or sulphonated anionic surfactant, from 0.2% to 1%. Suitable carboxylated anionic surfactant include fatty acids (and salts thereof), polycarboxylated anionic surfactants, alkyl ether carboxylates, alkyl polycarboxylated anionic surfactants, alkyl ether carboxylates, alkyl polyglycosides ether carboxylates, and mixtures thereof. Polycarboxylated anionic surfactants may be preferred since they result compositions which improve oil emulsification, improve greasy soap scum removal, and also improve surface shine. Polycarboxylated anionic surfactants also improve sequestration of transition metal ions.

Suitable fatty acids include the alkali salts of a C₈-C₂₄ fatty acid. Such alkali salts include the metal fully saturated salts like sodium, potassium and/or lithium salts as well as the ammonium and/or alkylammonium salts of fatty acids, preferably the sodium salt. Fatty acids of use herein contain from 8 to 22, from 8 to 20 or from 8 to 18 carbon atoms. Suitable fatty acids may be selected from caprylic acid, capric acid, lauric acid, myristic acid, palmitic acid, stearic acid, oleic acid, and mixtures of fatty acids suitably hardened, derived from natural sources such as plant or animal esters (e.g., palm oil, olive oil, coconut oil, soybean oil, castor oil, tallow, ground oil, fish oils and/or babassu oil). For example, coconut fatty acid is commercially available from KLK OLEA under the name PALMERA B1211.

Suitable polycarboxylated anionic surfactants are described in U.S. Pat. No. 5,376,298, EP0129328, WO03018733, and U.S. Pat. No. 5,120,326. Suitable examples are polyalkoxylate polycarboxylate surfactant, for instance, as described from column 3, line 30 to column 4, line 34 of U.S. Pat. No. 5,376,298.

Suitable polyalkoxylate polycarboxylates surfactant can have the empirical formula:

R—O—(CH(x)—CH(y)—O)ₙ—R¹

wherein R is a hydrophobic group, preferably a substituted, or unsubstituted, hydrocarbon group typically containing from 6 to 16 carbon atoms, from 8 to 14 carbon atoms, x and y are each independently selected from the group consisting of hydrogen, methyl, and succinic acid radicals, with the proviso that at least one x or y moiety per molecule is a succinic acid radical, wherein n is between 1 and 60, and wherein R¹ is hydrogen, substituted hydrocarbon, unsubstituted hydrocarbon having between 1 and 8 carbon atoms, sulfuric, or sulfonic radical, with any acid groups being neutralized by compatible cationic groups, e.g., sodium, potassium, alkanolammonium, magnesium, etc.

Suitable polyalkoxylate polycarboxylates surfactant can have the empirical formula:

R—O—(C₂H₄O)ₓ—[CH(L)CH(L)]_{y}—[CH₂CH(CH₃)O)_{z}Q

wherein R is a hydrocarbon hydrophobic group, e.g. alkyl, containing from 6 to 16, from 8 to 14 carbon atoms; x is a number from 0 to 60, from 4 to 50, or from 6 to 50; L is either a C1-3 alkyl group or a group having the formula —CH—(COO⁻)CH₂(COO⁻), with at least one L group in each molecule being —CH(COO⁻)CH₂(COO⁻); y is a number from 1 to 12, from 2 to 10, or from 3 to 8; z is a number from 0 to 20, from 0 to 15, or from 0 to 10; and Q is selected from the group consisting of H and sulfonate groups, the compound being rendered electrically neutral by the presence of cationic groups, which can be selected from the group consisting of sodium, potassium, and substituted ammonium, e.g., monoethanol ammonium, cations. Specific examples of such polyalkoxylate polycarboxylate surfactant include the following: Poly-Tergent® C9-51B (CS-1) (x=12; y=8; and Z=17); Poly-Tergent® C9-62P (x=4; y=3; and z=17); Poly-Tergent® C9-74P (x=10; y=3.5; and Z=3 5.); and Poly-Tergent® C9-92 (x=approximately 55; y=6.5; and z=0). R is believed to be an alkyl group such as a linear C9 alkyl group, and Q is believed to be H. The Poly-Tergent® surfactants are now sold under the Plurafac® trade name by BASF.

Suitable polycarboxylated anionic surfactants include alkoxylated polymer, alkyl ether, alkenedioic acid salts, for instance, as sold those under the Plurafac™ CS-10 tradename by BASF. Suitable alkyl ether carboxylates include laureth-5 carboxylate, available under the tradename of Empicol® CED 5 from Huntsman. Suitable alkyl ether carboxylates are described in WO2002/036081A1, from page 4 line 8 to page 5 line 10. Suitable alkyl polyglycosides ether carboxylates include EUCAROL AGE/ET (INCI: sodium coco-glucoside tartrate), EUCAROL AGE/EC INCI: disodium coco-glucoside citrate) and are described in WO1997/042299A1.

### Additional Surfactant

The hard surface cleaning composition may comprise up to 1% by weight of an additional surfactant, e.g. selected from: an amphoteric, zwitterionic, and mixtures thereof. The hard surface cleaning composition can comprise from 0.01% to 1% by weight of the additional surfactant.

Suitable zwitterionic surfactants typically contain both cationic and anionic groups in substantially equivalent proportions so as to be electrically neutral at the pH of use. The typical cationic group is a quaternary ammonium group, other positively charged groups like phosphonium, imidazolium and sulfonium groups can be used. The typical anionic hydrophilic groups are carboxylates and sulfonates, although other groups like sulfates, phosphonates, and the like can be used.

Some common examples of zwitterionic surfactants (such as betaine/sulphobetaine surfacants) are described in U.S. Pat. Nos. 2,082,275, 2,702,279 and 2,255,082. For example, Coconut dimethyl betaine is commercially available from Seppic under the trade name of Amonyl 265®. Lauryl betaine is commercially available from Albright & Wilson under the trade name Empigen BB/L®. A further example of betaine is Lauryl-imminodipropionate commercially available from Rhodia under the trade name Mirataine H2C-HA®.

Sulfobetaine surfactants can be particularly preferred, since they can improve soap scum cleaning. Examples of suitable sulfobetaine surfactants include tallow bis(hydroxyethyl) sulphobetaine, cocoamido propyl hydroxy sulphobetaines which are commercially available from Rhodia and Witco, under the trade name of Mirataine CBS® and ReWoteric AM CAS 15® respectively.

Amphoteric surfactants can be either cationic or anionic depending upon the pH of the composition. Suitable amphoteric surfactants include dodecylbeta-alanine, N-alkyltaurines such as the one prepared by reacting dodecylamine with sodium isethionate, as taught in U.S. Pat. No. 2,658,072, N-higher alkylaspartic acids such as those taught in U.S. Pat. No. 2,438,091, and the products sold under the trade name “Miranol”, as described in U.S. Pat. No. 2,528,378. Other suitable additional surfactants can be found in McCutcheon's Detergents and Emulsifers, North American Ed. 1980.

### Perfume

The composition comprises a perfume. The perfume is a mixture of odorant perfume raw materials, such as aromatic natural oils and aromatic chemicals, which taken together form a complex scent that delivers a number of benefits. These benefits may include the coverage of product base odor, scenting the product itself, and lingering scent radiating from the surface into the air after cleaning. When the composition is sprayed, the benefit may also include the delivery of scent to the air when spraying the composition on a surface, and the delivery of scent to the air while wiping the composition on the surface. The perfume may comprise at least 3, at least 5, at least 7, at least 11, or at least 15 perfume raw materials.

The perfume raw materials of the perfume may comprise at most 50%, or at most 40%, or at most 30%, for example from 0% to 20%, or from 0.01% to 10%, or from 0.02% to 5%, per weight of perfume raw materials comprising an α, β-unsaturated aldehyde function, an α, β-unsaturated ketone function, and/or an ester function.

For the purpose of the invention, an aromatic aldehyde/ketone wherein the aromatic ring is adjacent to the aldehyde or ketone group (e.g. anisic aldehyde or methyl β-naphthyl ketone) is considered as an α, β-unsaturated aldehyde/ketone.

The perfume raw materials of the perfume of the composition of the invention may comprise at most 50%, or at most 40%, or at most 30% for example from 0% to 20%, or from 0.01% to 10%, or from 0.02% to 5% per weight of perfume raw materials selected from benzyl acetate, methyl salicylate, allyl amyl glycolate, benzyl propionate, pomarose, methyl dihydrojasmonate, heliotropin, anisic aldehyde, delta damascone, amyl butyrate, iso-amyl iso-butyrate, b-ionone, carvone, iso-butyl iso butanoate, methyl b-naphtyl ketone, citronellyl butyrate, iso-propyl miristate.

The perfume raw materials of the perfume of the composition of the invention may comprise at least 20% per weight, in particular at least 30%, or at least 40%, or at least 50%, or at least 60%, or at least 70% for example from 80% to 100%, or from 90% to 99.9% per weight of perfume raw materials comprising an α, β-saturated aldehyde function, an α, β-saturated ketone function, an alcohol function, an ether function, a nitrile function, and/or being a terpene.

For the purpose of the invention an α, β-saturated aldehyde function is an aldehyde function without unsaturation in the α or β position.

For the purpose of the invention an α, β-saturated ketone function is a ketone function without unsaturation in the α or β position.

The perfume raw materials of the perfume of the composition of the invention may comprise at least 20% per weight, in particular at least 30%, or at least 40%, or at least 50%, or at least 60%, or at least 70% for example from 80% to 100%, or from 90% to 99.9% per weight of perfume raw materials which do not comprise α, β-unsaturated aldehyde function, an α, β-unsaturated ketone function, and/or an ester function.

The perfume raw materials of the perfume of the composition of the invention may comprise at least 20% per weight, in particular at least 30%, or at least 40%, or at least 50%, or at least 60%, or at least 70% for example from 80% to 100%, or from 90% to 99.9% per weight of perfume raw materials which comprise α, β-saturated aldehyde function, an α, β-saturated ketone function, an alcohol function, an ether function, a nitrile function, and/or are a terpene and which do not comprise an α, β-unsaturated aldehyde function, an α, β-unsaturated ketone function, and/or an ester function.

The perfume raw materials of the perfume of the composition of the invention may comprise at least 20% per weight, in particular at least 30%, or at least 40%, or at least 50%, or at least 60%, or at least 70% for example from 80% to 100%, or from 90% to 99.9% per weight of perfume raw materials selected from d-muscenone 1, ambrox, polysantol, phenylethyl dimethyl carbinol, hydroxycitronellal, undecavertol, citronellol, linalool, p-cresyl methyl ether, cis-3-hexenol, clonal, limonene, tobacarol 2, tobacarol 3, tobacarol 1, b-naphthyl methyl ether. Other perfumes suitable for use in the composition of the invention are described in EP 1 493 803 A1 and WO 2002/06437 A1.

The composition may comprise from 0.1% to 5%, or from 0.2% to 4%, or even from 0.3% to 4% of perfume by weight of composition.

### Optional Ingredients

Thickener: The liquid hard surface cleaning composition can comprise a thickener. An increased viscosity, especially low shear viscosity, provides longer contact time and therefore improved penetration of greasy soil and/or particulated greasy soil to improve cleaning effectiveness, especially when applied neat to the surface to be treated. Moreover, a high viscosity improved the contact time for the hard surface cleaning composition on inclined surfaces. The alkyl pyrrolidones of use in the present invention have been found to improve the viscosity of thickened hard surface cleaning compositions and are hence particularly suited for cleaning inclined surfaces. Hence, the liquid hard surface cleaning compositions comprising a thickener can have a viscosity from 1 cps to 650 cps, from 100 cps to 550 cps, from 150 cps to 450 cps, from 150 cps to 300 cps or from 150 cps to 250 cps when measured at 20° C. with a AD1000 Advanced Rheometer from Atlas® shear rate 10 s⁻¹ with a coned spindle of 40 mm with a cone angle 2° and a truncation of ±60 μm.

Suitable thickeners include polyacrylate based polymers, e.g. hydrophobically modified polyacrylate polymers; hydroxyl ethyl cellulose, hydrophobically modified hydroxyl ethyl cellulose, xanthan gum, hydrogenated castor oil (HCO) and mixtures thereof.

Preferred thickeners can be polyacrylate based polymers, e.g. hydrophobically modified polyacrylate polymers. A water-soluble copolymer based on main monomers acrylic acid, acrylic acid esters, vinyl acetate, methacrylic acid, acrylonitrile and mixtures thereof, e.g. the copolymer is based on methacrylic acid and acrylic acid esters having appearance of milky, low viscous dispersion. One suitable example of a hydrologically modified polyacrylate polymer is Rheovis® AT 120, which is commercially available from BASF.

Other suitable thickeners are hydroxethylcelluloses (HM-HEC), e.g. hydrophobically modified hydroxyethylcellulose. Suitable hydroxethylcelluloses (HM-HEC) are commercially available from Aqualon/Hercules under the product name Polysurf76® and W301 from 3V Sigma.

Xanthan gum is one suitable thickener used herein. Xanthan gum is a polysaccharide commonly used rheology modifier and stabilizer. Xanthan gum is produced by fermentation of glucose or sucrose by the xanthomonas campestris bacterium. Suitable Xanthan gum is commercially available under trade name Kelzan T® from CP Kelco.

Hydrogenated castor oil is one suitable thickener used herein. Suitable hydrogenated castor oil is available under trade name THIXCIN R from Elementis.

A suitable thickener for use herein is a modified methacrylic acid/acrylic acid copolymer Rheovis® AT 120, which is commercially available from BASF. When used, the liquid hard surface cleaning composition may comprise from 0.1% to 1% by weight of the total composition of said thickener.

Chelating agent: The hard surface cleaning composition can comprise a chelating agent or crystal growth inhibitor. Suitable chelating agents, in combination with the surfactant system, improve the shine benefit. The addition of a chelant, especially chelants selected from the group consisting of: amino-carboxylates (such as diethylenetriaminepentaacetic acid [DTPA]), carboxylic acid esters of inulin, phosphonate chelating agents, and mixtures thereof, surprisingly improve greasy soap scum and water-mark removal as well as shine from the treated surface. Chelating agent can be incorporated into the compositions in amounts ranging from 0.025% to 5.0% by weight of the total composition, from 0.05% to 3%, or from 0.1% to 1%.

Particularly preferred chelants can be selected from the group consisting of: carboxylic acid esters of inulin, phosphonate chelating agents, and mixtures thereof.

Suitable carboxylic acid esters of inulin include those described in WO2010106077 A, such as carboxylated fructan selected from the group consisting of: carboxyalkylfructan, e.g. carboxyalkylinulin, having from 1 to 4 carbon atoms in the alkyl moiety; dicarboxyfructan having a degree of oxidation (DO) of from 10 to 100%, 20 to 90%, expressed as a molar percentage of monosaccharide units converted into the corresponding dicarboxy analogues; 6-carboxyfructan, preferably 6-carboxyinulin; fructan polycarboxylic acid, inulin polycarboxylic acid, having a degree of carboxyalkylation or carboxyacylation of from 0.2 to 3.0; and mixtures thereof.

Suitable phosphonate chelating agents include ethylene diamine tetra methylene phosphonates, and diethylene triamine penta methylene phosphonates (DTPMP). The phosphonate compounds may be present either in their acid form or as salts of different cations on some or all of their acid functionalities. A preferred phosphonate chelating agent can be diethylene triamine penta methylene phosphonate (DTPMP). Such phosphonate chelating agents are commercially available from Monsanto under the trade name DEQUEST®. Other suitable phosphonate chelating agents include:
a) water-soluble organic phosphonic acids or salts thereof having the formula:

R₁N[CH₂PO₃H₂]₂, wherein R1 is a:
[(lower)alkyl]N[CH₂PO₃H₂]₂ or salt thereof, or
[(lower)alkyl]N[CH₂PO₃H₂][(lower)alkylene]N[CH₂PO₃H₂]₂ or salt thereof, or
[CH₂PO₃H₂] moiety or salt thereof;
b) phosphonocarboxylic acids, or salts thereof, including those of formula (A) and (B):

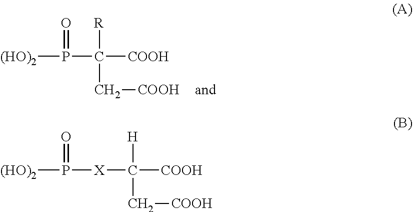

wherein R is hydrogen, alkyl, alkenyl, or alkynyl radical having 1 to 4 carbon atoms, an aryl, cycloalkyl, or aralkyl radical, or the radical selected from the following:

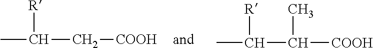

wherein R′ is hydrogen, alkyl radical of 1 to 4 carbon atoms, or a carboxyl radical;
and X is selected from the following:

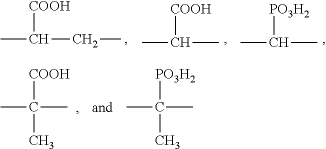

wherein the —PO₃H₂ group is the phosphono group:

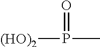

Such phosphonate chelating agents are described in EP17150033.3.

A biodegradable chelating agent of use herein is ethylene diamine N,N′- disuccinic acid, or alkali metal, or alkaline earth, ammonium or substitutes ammonium salts thereof or mixtures thereof. Ethylenediamine N,N′- disuccinic acids, especially the (S,S) isomer have been extensively described in U.S. Pat. No. 4,704,233, Nov. 3, 1987, to Hartman and Perkins. Ethylenediamine N,N′- disuccinic acids is, for instance, commercially available under the tradename (S,S)EDDS® from Palmer Research Laboratories. Another biodegradable chelating agent is L-glutamic acid N,N-diacetic acid (GLDA) commercially available under tradename Dissolvine 47S from Akzo Nobel.

Amino carboxylates of use herein include ethylene diamine tetra acetates, diethylene triamine pentaacetates, diethylene triamine pentaacetate (DTPA), N-hydroxyethylethylenediamine triacetates, nitrilotriacetates, ethylenediamine tetrapropionates, triethylenetetraaminehexa-acetates, ethanoldiglycines, and methyl glycine diacetic acid (MGDA), both in their acid form, or in their alkali metal, ammonium, and substituted ammonium salt forms. Particularly suitable amino carboxylate to be used herein is propylene diamine tetracetic acid (PDTA) which is, for instance, commercially available from BASF under the trade name Trilon FS® and methyl glycine di-acetic acid (MGDA). An exemplary aminocarboxylate used herein is diethylene triamine pentaacetate (DTPA) from BASF. Further carboxylate chelating agents of use herein include salicylic acid, aspartic acid, glutamic acid, glycine, malonic acid or mixtures thereof.

Polymers: The liquid hard surface cleaning composition may comprise a polymer. It has been found that the presence of a specific polymer as described herein, when present, allows further improving the grease removal performance of the liquid composition due to the specific sudsing/foaming characteristics they provide to the composition. Suitable polymers of use herein are disclosed in co-pending EP patent application EP2272942 (09164872.5) and granted European patent EP2025743 (07113156.9).

The polymer can be selected from the group consisting of: a vinylpyrrolidone homopolymer (PVP); a polyethyleneglycol dimethylether (DM-PEG); a vinylpyrrolidone/dialkylaminoalkyl acrylate or methacrylate copolymers; a polystyrenesulphonate polymer (PSS); a poly vinyl pyridine-N-oxide (PVNO); a polyvinylpyrrolidone/vinylimidazole copolymer (PVP-VI); a polyvinylpyrrolidone/polyacrylic acid copolymer (PVP-AA); a polyvinylpyrrolidone/vinylacetate copolymer (PVP-VA); a polyacrylic polymer or polyacrylicmaleic copolymer; and a polyacrylic or polyacrylic maleic phosphono end group copolymer; a polyethyleneimine polymer such as carboxylated polyethyleineimine; and mixtures thereof.

Polyethyleneimine polymers such as carboxylated polyethyleineimine can be particularly preferred. Suitable polyethyleineimine polymers may be linear or branched, charged or uncharged. They may be hyperbranched or have a dendritic form. They may contain primary, secondary, and/or tertiary amino groups. They are carboxylated by reaction with fatty acids, carboxylic acid and/or carboxylic acid derivatives (such as acrylic acid, maleic acid, maleic anhydride, etc.). They may be alkoxylated, amidated, etc. They may be amphiphilic, amphoteric, alkoxylated, etc. In some embodiments, they may have molecular weights of from about 300 to about 2,000,000. Examples of suitable polyethyleineimine polymers include materials sold by BASF under the trade name Lupasol® and by Nippon Shokubai under the trade name EPOMIN. Examples include Lupasol® FG, Lupasol® G 20, Lupasol® G 35, Lupasol® G 100, Lupasol® G 500, Lupasol® HF, Lupasol® P, Lupasol® PS, Lupasol® PR 8515, Lupasol® WF, Lupasol® FC, Lupasol® PE, Lupasol® HEO 1, Lupasol® PN 50, Lupasol® PN 60, Lupasol® PO 100, Lupasol® SK, etc.

Typically, the liquid hard surface cleaning composition may comprise from 0.005% to 5.0% by weight of the total composition of said polymer, from 0.01% to 4.0%, from 0.1% to 3.0% and from 0.20% to 1.0%.

Branched fatty alcohol: The hard surface cleaning composition may comprise a branched fatty alcohol, particularly as suds suppressors. Suitable branched fatty alcohols include the 2-alkyl alkanols having an alkyl chain comprising from 6 to 16, from 7 to 13, from 8 to 12, or from 8 to 10 carbon atoms and a terminal hydroxy group, said alkyl chain being substituted in the α position (i.e., position number 2) by an alkyl chain comprising from 1 to 10, from 2 to 8 and 4 to 6 carbon atoms. Such suitable compounds are commercially available, for instance, as the Isofol® series such as Isofol® 12 (2-butyl octanol) or Isofol® 16 (2-hexyl decanol) commercially available from Sasol

Typically, the liquid hard surface cleaning composition may comprise up to 2.0% by weight of the total composition of said branched fatty alcohol, e.g. from 0.10% to 1.0%, from 0.1% to 0.8% and from 0.1% to 0.5%.

Solvent: The liquid hard surface cleaning compositions may comprise a solvent or mixtures thereof.

Suitable solvents may be selected from the group consisting of: ethers and diethers having from 4 to 14 carbon atoms; glycols or alkoxylated glycols; alkoxylated aromatic alcohols; aromatic alcohols; alkoxylated aliphatic alcohols; aliphatic alcohols; C₈-C₁₄ alkyl and cycloalkyl hydrocarbons and halohydrocarbons; C₆-C₁₆ glycol ethers; terpenes; and mixtures thereof. Ethers such as n-butoxypropanol and glycol ethers such as dipropylene glycol n-butyl ether can be particularly preferred.

When present, the solvent can be present at a level of from 0.1 to 10%, or 0.2 to 5.0%, or 0.5 to 3% by weight of the composition.

Solfactants: The liquid composition may comprise solfactants, i.e. compounds having efficacy as both solvents and surfactants. Suitable solfactants include but are not limited to glycerin ether ethoxylate solfactants of the formula:

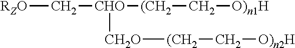

wherein R_{z} is a linear or branched alkyl group having 1 to 30 carbon atoms, wherein n₁ and/or n₂ is 1 to 20. Suitable solfactants are described in US 2014/0005273 A1.

Perfumes: The hard surface cleaning composition comprises a perfume. Suitable perfumes provide an olfactory aesthetic benefit and/or mask any “chemical” odour that the product may have. The most preferred perfumes are those that deliver a high perfume intensity and longevity.

Other optional ingredients: The liquid hard surface cleaning compositions may comprise a variety of other optional ingredients depending on the technical benefit aimed for and the surface treated. Suitable optional ingredients of use herein include builders, other polymers, buffers, bactericides, hydrotropes, colorants, stabilisers, radical scavengers, abrasives, soil suspenders, brighteners, anti-dusting agents, dispersants, dye transfer inhibitors, pigments, silicones and/or dyes.

Exemplary compositions comprise:
a) from about 0.1% to about 1% by weight of the composition of anionic surfactant, e.g. an alkyl sulfate;
b) from about 0% to about 1% or from 0.1 to 0.8% by weight of the composition of amine oxide surfactant, preferably C12/14 amine oxide;
c) from about 0.5% to about 3% by weight of the composition of a non-ionic surfactant, e.g. an alcohol ethoxylate;
d) from about 0.5% to about 3% by weight of the composition of polyethylene glycol having a weight average molecular weight from 6,000 to 10,000; and
e) from 0.2 to 2% by weight of the composition of perfume.

### Wipe or Pad

The composition of the invention is suitable for use in an article of manufacture, wherein the composition is comprised in a spray dispenser, or in a wipe or pad. Suitable wipes can be fibrous. Suitable fibrous wipes can comprise polymeric fibres, cellulose fibres, and combinations thereof. Suitable cellulose-based wipes include kitchen wipes, and the like. Suitable polymeric fibres include polyethylene, polyester, and the like. Polymeric fibres can be spun-bonded to form the wipe. Methods for preparing thermally bonded fibrous materials are described in U.S. application Ser. No. 08/479,096 (Richards et al.), filed Jul. 3, 1995 (see especially pages 16-20) and U.S. Pat. No. 5,549,589 (Homey et al.), issued Aug. 27, 1996 (see especially Columns 9 to 10). Suitable pads include foams and the like, such as HIPE-derived hydrophilic, polymeric foam. Such foams and methods for their preparation are described in U.S. Pat. No. 5,550,167 (DesMarais), issued Aug. 27, 1996; and commonly assigned U.S. patent application Ser. No. 08/370,695 (Stone et al.), filed Jan. 10, 1995.

### Method of Cleaning a Surface

The compositions described herein are particularly suited for cleaning surfaces selected from the group consisting of: ceramic tiles, enamel, stainless steel, Inox®, Formica®, vinyl, no-wax vinyl, linoleum, melamine, glass, plastics and plastified wood, and combinations thereof. The compositions of the present invention are particularly suited for removing greasy soap scum, water-marks, and combinations thereof, even though the compositions can be alkaline. When the formula is thickened, they are particularly suited for removing such greasy soap scum and/or water-marks from inclined surfaces, especially when the composition is applied as a spray, or applied using a wipe or pad.

For general cleaning, especially of floors and counter-tops, the method of cleaning comprises the steps of:
a) optionally diluting the hard surface cleaning composition of the present invention;
b) applying the hard surface cleaning composition to a hard surface;
c) optionally rinsing and/or wiping the surface.

The hard surface cleaning composition may be diluted to a level of from 0.1% to 2.0%, or from 0.3% to 1.5% by volume. The composition may be diluted to a level of from 0.4% to 0.6% by volume, especially when the composition has a total surfactant level of greater than or equal to 5% by weight. Where the composition has a total surfactant level of less than 5% by weight, the composition may be diluted to a level of from 0.7% to 1.4% by volume. In some embodiments, the composition is diluted with water.

The dilution level is expressed as a percent defined as the fraction of the alkaline liquid hard surface cleaning composition, by volume, with respect to the total amount of the diluted composition. For example, a dilution level of 5% by volume is equivalent to 50 ml of the composition being diluted to form 1000 ml of diluted composition.

The diluted composition can be applied by any suitable means, including using a mop, sponge, cloth, wipe, pad, or other suitable implement.

Alternatively, the hard surface cleaning composition can be a “ready-to-use” composition, where dilution is not necessary. Such ready-to-use compositions can be comprised in a spray container.

In addition, for particularly dirty or greasy spots, the hard surface cleaning composition can be applied neat to the hard surface. The compositions of the present invention provide improved penetration and removal of the stain, and especially of greasy stains, leading to improved surfactancy action and stain removal.

By “neat”, it is to be understood that the composition is applied directly onto the surface to be treated without undergoing any significant dilution, i.e., the liquid composition herein is applied onto the hard surface as described herein, either directly or via an implement such as a sponge, without first diluting the composition. By “without undergoing any significant dilution”, what is meant is that the composition is diluted by less than 10 wt %, less than 5 wt %, or less than 3 wt %. Such dilutions can arise from the use of damp implements to apply the composition to the hard surface, such as sponges which have been “squeezed” dry.

In another embodiment of the present invention said method of cleaning a hard surface includes the steps of applying, e.g. spraying, said liquid composition onto said hard surface, leaving said liquid composition to act onto said surface for a period of time to allow said composition to act, with or without applying mechanical action.

### Methods

### A) pH Measurement

The pH is measured on the neat composition, at 25° C., using a Sartarius PT-10P pH meter with gel-filled probe (such as the Toledo probe, part number 52 000 100), calibrated according to the instructions manual.

### B) Shine

The shine test is done with a soil mixture which consists of a mixture of consumer relevant soils such as oil, polymerized oil, particulates, pet hair, granulated sugar etc. The black glossy ceramic tiles (Black Glossy Sphinx ceramic tiles 20×25cm, Ref H07300, available at Carobati, Boomsesteenweg 36, 2630 Aartselaar www.carobati.be) are soiled with 0.03 g soil mixture (18.01 wt % Crisco oil [purchased from a North American supermarket], 2.08 wt % of polymerized Crisco oil [polymerized by pumping air at 1 PSI (0.0689 bar) through 500 g of Crisco oil in a 2 L beaker, while stirring at 125 rpm on a hot-plate set at 204° C. for 67 hours, before covering with an aluminium foil and leaving at 204° C. for an additional 30 hours, then cooling to room temperature with hot-plate turned off for 64 hours before heating at 204° C. for 64 hours, before cooling at room temperature with the hot-plate turned off for an additional 24 hours, so that the final viscosity of the oil is between 1800 and 2200 cps, when measured using a Brookfield DVT with spindle nr. 31 at 6 rpm], 28.87 wt % of granulated sugar, and 51.04 wt % of vacuum cleaner soil [“Vacuum Cleaner Soil” supplied by Chem-Pack, 2261 Spring Grove Avenue, Cincinnati Ohio 45214 USA]) by blending the soil mixture with isopropyl alcohol at 1.45wt % and spraying onto the tile.

The tiles are then cleaned with the liquid hard surface cleaning composition which has been diluted to a level of 0.48 wt % using water having a hardness of 0.93 mmol/l, using a non-woven cloth soaked in the diluted cleaning solution, and wiping first horizontally, then vertically, and then again horizontally. The cloth is then rinsed in the diluted liquid hard surface cleaning composition, and the tiles cleaned in the same manner, using the other side of the nonwoven cloth.

After letting the tiles dry, the tiles are then graded using the grading scale described below, versus tiles cleaned using the reference composition. A positive value means improved shine versus the reference, a negative value means worse shine versus the reference.
Shine grading scale: (average of 3 graders, each grading 2 sets of tiles per product comparison, for a total of six gradings):
0=I see no difference
1=I think there is difference
2=I am sure there is a slight difference
3=I am sure there is a difference
4=I am sure there is a big difference
   The shine gradings were averaged to provide the final shine grading.

### EXAMPLES

The following compositions were made by simple mixing. The addition of 1% polyalkylene glycol of molecular weight 8,000, to the dilute “all-purpose-cleaning” (APC) formulation allows to increase perfume up to 3% and still having a clear, stable solution.

| | Ex A* | Ex 1 | Ex 2 | Ex 3 | Ex 4 | Ex 5 |
|---|---|---|---|---|---|---|
| | wt % | wt % | wt % | wt % | wt % | wt % |
| C12-14 EO11¹ | 1.78 | 1.78 | 1.78 | 1.78 | 1.78 | 1.78 |
| Lialet 111-8¹ | 0.60 | 0.60 | 0.60 | 0.60 | 0.60 | 0.60 |
| HLAS | 0.36 | 0.36 | 0.36 | 0.36 | 0.36 | 0.36 |
| C12-14 Amine oxide² | 0.12 | 0.12 | 0.12 | 0.12 | 0.12 | 0.12 |
| Topped palm kernel | 0.15 | 0.15 | 0.15 | 0.15 | 0.15 | 0.15 |
| Fatty acid | | | | | | |
| Polyethyleneoxide³ | — | — | 1.0 | — | — | 1.0 |
| DTPMP⁴ | 0.1 | 0.1 | 0.1 | 0.1 | 0.1 | 0.1 |
| Sodium carbonate | 0.9 | 0.9 | 0.9 | 0.9 | 0.9 | 0.9 |
| NaOH | 0.26 | 0.26 | 0.26 | 0.26 | 0.26 | 0.26 |
| Citric acid | 0.3 | 0.3 | 0.3 | 0.3 | 0.3 | 0.3 |
| Preservative | q.s. | q.s. | q.s. | q.s. | q.s. | q.s. |
| Perfume 1⁵ | 0.42 | 0.8 | 3.0 | | | |
| Perfume 2⁶ | | | | 0.45 | 1.0 | 2.3 |
| pH | 11 | 11 | 11 | 11 | 11 | 11 |
| Physical stability | Clear | Hazy | Clear | Clear | Hazy | Clear |
| at 21° C. | | | | | | |

*Comparative
** Reference
¹nonionic surfactant commercially available from Sasol
²amine oxide nonionic surfactant, supplied by Huntsman
³PolyOx ™ molecular weight of 8,000, supplied by DOW
⁴Diethylenetriaminepenta(methylene-phosphonic acid) commercially available from ThermPhos international BV
⁵Effective Alkane Carbon Number (EACN) = −1
⁶EACN = −7

Effect of polyethylene oxide Mw. Increased perfume solubilization is enabled for Mw above 4000 with an optimum at 8000.

| | Ex 6 | Ex 7 | Ex 8 | Ex 9 | Ex 10 | Ex 11 |
|---|---|---|---|---|---|---|
| | wt % | wt % | wt % | wt % | wt % | wt % |
| C12-14 EO11¹ | 1.8 | 1.8 | 1.8 | 1.8 | 1.8 | 1.8 |
| Lialet 111-8¹ | 0.60 | 0.60 | 0.60 | 0.60 | 0.60 | 0.60 |
| HLAS | 0.36 | 0.36 | 0.36 | 0.36 | 0.36 | 0.36 |
| C12-14 Amine oxide² | 0.12 | 0.12 | 0.12 | 0.12 | 0.12 | 0.12 |
| Topped palm kernel | 0.15 | 0.15 | 0.15 | 0.15 | 0.15 | 0.15 |
| Fatty acid | | | | | | |
| Polyethyleneoxide³ | 1.0 | | | | | |
| molecular weight of 100 | | | | | | |
| Polyethyleneoxide³ | | 1.0 | | | | |
| molecular weight of 400 | | | | | | |
| Polyethyleneoxide³ | | | 1.0 | | | |
| molecular weight of 1,000 | | | | | | |
| Polyethyleneoxide³ | | | | 1.0 | | |
| molecular weight of 4,000 | | | | | | |
| Polyethyleneoxide³ | | | | | 1.0 | |
| molecular weight of 8,000 | | | | | | |
| Polyethyleneoxide³ | | | | | | 1.0 |
| molecular weight of 9,000 | | | | | | |
| DTPMP⁴ | 0.1 | 0.1 | 0.1 | 0.1 | 0.1 | 0.1 |
| Sodium carbonate | — | — | — | — | — | — |
| Citric acid | 0.075 | 0.075 | 0.075 | 0.075 | 0.075 | 0.075 |
| NaOH | 0.10 | 0.10 | 0.10 | 0.10 | 0.10 | 0.10 |
| Preservative | q.s. | q.s. | q.s. | q.s. | q.s. | q.s. |
| Maximum wt % Perfume | 0.50 | 0.50 | 1.0 | 2.5 | 3.0 | 2.5 |
| 1 solubilised⁴ | | | | | | |
| pH | 7.5 | 7.5 | 7.5 | 7.5 | 7.5 | 7.5 |
| Physical stability | Clear | Clear | Clear | Clear | Clear | Clear |
| at 21° C. | | | | | | |

* Comparative
** Reference
¹nonionic surfactant commercially available from Sasol
²amine oxide nonionic surfactant, supplied by Huntsman
³PolyOx ™, supplied by DOW
⁴Diethylenetriaminepenta(methylene-phosphonic acid) commercially available from ThermPhos international BV
⁴Effective Alkane Carbon Number (EACH) = −1

The addition of polyethylene oxide improves Shine performance

| | Ex 12 | Ex 13 | Ex 14 | Ex 15 | Ex 16 | Ex 17 |
|---|---|---|---|---|---|---|
| | wt % | wt % | wt % | wt % | wt % | wt % |
| C12-14 EO11¹ | 1.8 | 1.8 | 1.8 | 1.8 | 1.8 | 1.8 |
| Lialet 111-8¹ | 0.60 | 0.60 | 0.60 | 0.60 | 0.60 | 0.60 |
| HLAS | 0.36 | 0.36 | 0.36 | 0.36 | 0.36 | 0.36 |
| C12-14 Amine oxide² | 0.12 | 0.12 | 0.12 | 0.12 | 0.12 | 0.12 |
| Topped palm kernel | 0.15 | 0.15 | 0.15 | 0.15 | 0.15 | 0.15 |
| Fatty acid | | | | | | |
| Polyethyleneoxide³ | 0 | 1.00 | 0 | 1.00 | 0 | 0.60 |
| molecular weight of | | | | | | |
| 8,000 | | | | | | |
| DTPMP⁴ | 0.1 | 0.1 | 0.1 | 0.1 | 0.1 | 0.1 |
| Sodium carbonate | 0.9 | 0.9 | 0 | 0 | 0 | 0 |
| Citric acid | 0.30 | 0.30 | 0.075 | 0.075 | 0.075 | 0.075 |
| NaOH | 0.26 | 0.26 | 0.10 | 0.10 | 0.10 | 0.10 |
| Preservative | q.s. | q.s. | q.s. | q.s. | q.s. | q.s. |
| Perfume 1 ⁵ | 0.42 | 2.6 | 0.42 | 2.6 | 0.42 | 0.8 |
| pH | 11 | 11 | 7.5 | 7.5 | 7.5 | 7.5 |
| Physical stability | Clear | Clear | Clear | Clear | Clear | Clear |
| at 21° C. | | | | | | |
| Shine Absolute grading | 4 | 2 | 3 | 2 | 3 | 2 |
| (0 best-6 worst) | | | | | | |
| Relative shine vs | ref | +2 | ref | +2 | ref | +2 |
| ref (PSU) | | | | | | |

* Comparative
** Reference
¹nonionic surfactant commercially available from Sasol
²amine oxide nonionic surfactant, supplied by Huntsman
³PolyOx ™, supplied by DOW
⁴Diethylenetriaminepenta(methylene-phosphonic acid) commercially available from ThermPhos international BV
⁵ Effective Alkane Carbon Number (EACN) = −1

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

What is claimed is:

1. An aqueous hard surface cleaning composition comprising:
(a) from about 0.1% to about 5% by weight of the composition of a surfactant system;
(b) from about 0.1% to about 5% by weight of the composition of polyalkylene glycol having a weight average molecular weight from about 4,000 to about 12,000; and
(c) from about 0.1% to about 5% by weight of the composition of perfume.

2. The composition according to claim 1, wherein the polyalkylene glycol has a weight average molecular weight from about 4,000 to about 10,000.

3. The composition according to claim 1, wherein the polyalkylene glycol has a weight average molecular weight from about 6,000 to about 10,000.

4. The composition according to claim 1, wherein the surfactant system comprises more than one surfactant selected from the group consisting of anionic surfactant, non-ionic surfactant, amine oxide surfactant, betaine surfactant and mixtures thereof.

5. The composition according to claim 1, wherein the surfactant system comprises anionic surfactant, non-ionic surfactant and amine oxide surfactant.

6. The composition according to claim 1, wherein the surfactant system comprises:
a) from about 0.1% to about 1% by weight of the composition of anionic surfactant;
b) from about 0.1% to about 1% by weight of the composition of amine oxide surfactant; and
c) from about 0.5% to about 3% by weight of the composition of a non-ionic surfactant.

7. The composition according to claim 1, wherein the surfactant system comprises an anionic surfactant selected from the group consisting of: alkyl sulphate, alkyl alkoxylated sulphate, sulphonic acid or sulphonate surfactant, carboxylated anionic surfactant, and mixtures thereof.

8. The composition according to claim 1, wherein the surfactant system comprises an alkyl sulphate.

9. The composition according to claim 1, wherein the surfactant system comprises an anionic surfactant comprising HLAS, an amine oxide surfactant comprising C12/C14 amine oxide and a non-ionic surfactant comprising an alkoxylated nonionic surfactant.

10. The composition according to claim 1, wherein the surfactant system comprises an anionic surfactant comprising HLAS, an amine oxide surfactant comprising C12/C14 amine oxide and a non-ionic surfactant comprising an ethoxylated alcohol.

11. The composition according to claim 1, wherein the composition comprises:
(a) from about 0.1% to about 1% by weight of the composition of an anionic surfactant;
(b) from about 1% to about 3% by weight of the composition of non-ionic surfactant;
(c) from about 0.1% to about 5% by weight of the composition of polyalkylene glycol having a weight average molecular weight from about 4,000 to about 10,000.

12. The composition according to claim 1, wherein the surfactant system and the perfume are in a weight ratio of from about 4 to 1 to about 1 to 2.

13. The composition according to claim 1, wherein the composition further comprises a chelant.

14. The composition according to claim 1, wherein the composition further comprises a chelant selected from the group consisting of: amino-carboxylates, carboxylic acid esters of inulin, phosphonate chelating agents, and mixtures thereof.

15. The composition according to claim 1, wherein the composition further comprises a chelant, at a level of from about 0.05% to about 4.0% by weight of the total composition.

16. The composition according to claim 1, wherein the composition has a pH of from about 5 to about 12.measured on the neat composition, at 25° C.

17. The composition according to claim 1, wherein the composition further comprises a pH adjusting system.

18. The composition according to claim 1, wherein the composition further comprises a pH adjusting system and wherein the pH adjusting system comprise an alkaline agent and an organic acid.

19. A method of cleaning a hard surface, comprising the steps of:
(a) optionally diluting the composition according to claim 1;
(b) applying the composition to the hard surface; and
(c) optionally rinsing and/or wiping the surface.
